(19) United States
(12) Patent Application Publication
(10) Pub. No.: US 2004/0108692 A1
(43) Pub. Date: Jun. 10, 2004

(54) Gas bag restraint device

(75) Inventors: Andreas Heil, Aschaffenburg (DE); Michael Schneider, Sulzbach (DE)

Correspondence Address: TAROLLI, SUNDHEIM, COVELL, TUMMINO & SZABO L.L.P., 1111 LEADER BLDG., 526 SUPERIOR AVENUE, CLEVELAND, OH, 44114-1400, US

(73) Assignee: TRW Automotive Safety Systems GmbH

(21) Appl. No.: 10/727,002

(22) Filed: Dec. 3, 2003

(30) Foreign Application Priority Data
Dec. 5, 2002 (DE) 202 18 874.4

(51) Int. Cl. B60R 21/20

(52) U.S. Cl. 280/728.3

(57) ABSTRACT

A gas bag restraint device comprises a gas bag module which has a gas bag and a covering cap tearing open on inflation of the gas bag. The covering cap covers a ring-shaped outlet opening for the gas bag and has a central section, which in an opened state of the gas bag module is surrounded by the outlet opening. The central section is delimited by a ring-shaped, peripherally closed tear line of radially outwardly adjoining sections of the covering cap, the tear line adjoining an inner edge of the outlet opening.

### TECHNICAL FIELD

The invention relates to a gas bag restraint device.

### BACKGROUND OF THE INVENTION

A gas bag restraint device usually comprises a gas bag module which has a gas bag and a covering cap which tears open on inflation of the gas bag, the covering cap covering a ring-shaped outlet opening for the gas bag and having a central section which in the opened state is surrounded by the outlet opening. Such a gas bag restraint device is known from DE 197 49 914 A1. The gas bag is a so-called ring gas bag, which has a central indentation originating from the front wall and projecting to close to the gas generator. The central section remains stationary on tearing open of the covering cap. In approximately the center of the outlet opening, the covering cap has a ring-shaped tear line, from which radial tear lines extend outwards and inwards. If the covering cap is opened, then inner and outer segment sections are produced starting from the ring-shaped tear line, which swing outwards in order to free the outlet opening.

The invention provides a gas bag restraint device in which the covering cap offers the gas bag a slight resistance on unfolding, namely in the region of the indentation of the gas bag.

### BRIEF SUMMARY OF THE INVENTION

According to the invention, a gas bag restraint device comprises a gas bag module which has a gas bag and a covering cap tearing open on inflation of the gas bag. The covering cap covers a ring-shaped outlet opening for the gas bag and has a central section, which in an opened state of the gas bag module is surrounded by the outlet opening. The central section is delimited by a ring-shaped, peripherally closed tear line of radially outwardly adjoining sections of the covering cap, the tear line adjoining an inner edge of the outlet opening.

In prior art, the tear line was approximately in the center of the outlet opening, in the gas bag restraint device according to the invention, on the inner edge thereof. This means that the central section does not have any radial tear lines through which segments are produced on tearing open, along which the indentation of the gas bag slides on unfolding. In this region, therefore, no extension or the like has to be swung outwards on the central section. The central section offers little resistance to the unfolding gas bag because, as already explained, the tear line which delimits the outer periphery of the central section is close to the outlet opening.

The tear line preferably even defines the inner edge of the outlet opening.

According to the preferred embodiment, the central section is constructed so as to be rigid, i.e. from the same material as the covering cap, which is usually constructed so as to be relatively rigid.

The central section can be covered externally at least partially by a separate plaque piece. This plaque piece can also serve to fasten the central section, by preventing the central section from a free movement as the covering opens.

In this connection, the tear line is to adjoin the outer edge of the plaque piece as immediately as possible, so that the holding force exerted by the plaque piece onto the central section lies as close as possible to the tear line.

The plaque piece can have a depression on the underside, into which a bead-like extension of the central section projects, in order to additionally achieve a type of form-fitting connection.

The covering cap is in addition to adjoin the plaque piece externally substantially in a flush manner, which means the plaque piece is not to project with respect to the covering cap in axial direction (i.e. in the direction of the axis of the steering wheel, which carries the gas bag restraint device). Thereby, one can avoid having to construct the plaque piece laterally in an expensive manner, in order to match the front side of the plaque piece, which is of high quality appearance.

A simple fastening of the covering cap on the plaque piece can be achieved in that the central section has a mounting opening for the plaque piece. The mounting opening must be constructed such that the covering cap can be placed onto the plaque piece from above, so that the plaque piece finds its way through the mounting opening and the inner edge of the central section snaps in place underneath a laterally projecting edge of the plaque piece. In this way, a detent- or snap connection can be achieved between the central section and the plaque piece, so that without great expenditure, at the end of the installation of the gas bag module, the covering cap is simply pushed from above onto the latter.

### BRIEF DESCRIPTION OF THE DRAWINGS

FIG. 1 shows a stylized sectional view of a gas bag restraint device according to the invention, with an unfolded gas bag,

FIG. 2 shows a partial top view onto the covering cap of the gas bag module,

FIG. 3 shows a sectional view along line III-III in FIG. 2, which shows the fastening of the covering cap on the plaque piece, and

FIG. 4 shows a sectional view along line IV-IV in FIG. 2, which likewise shows the fastening of the covering cap on the plaque piece.

### DETAILED DESCRIPTION OF THE PREFERRED EMBODIMENT

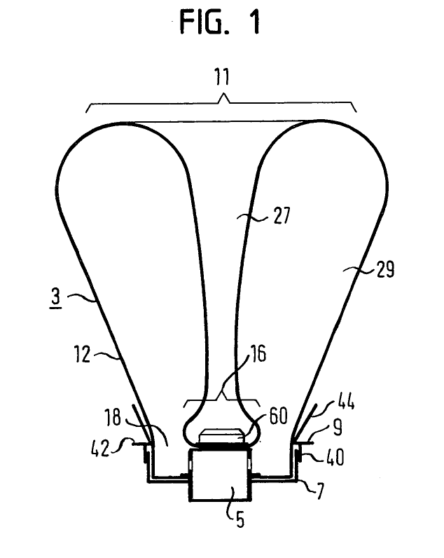

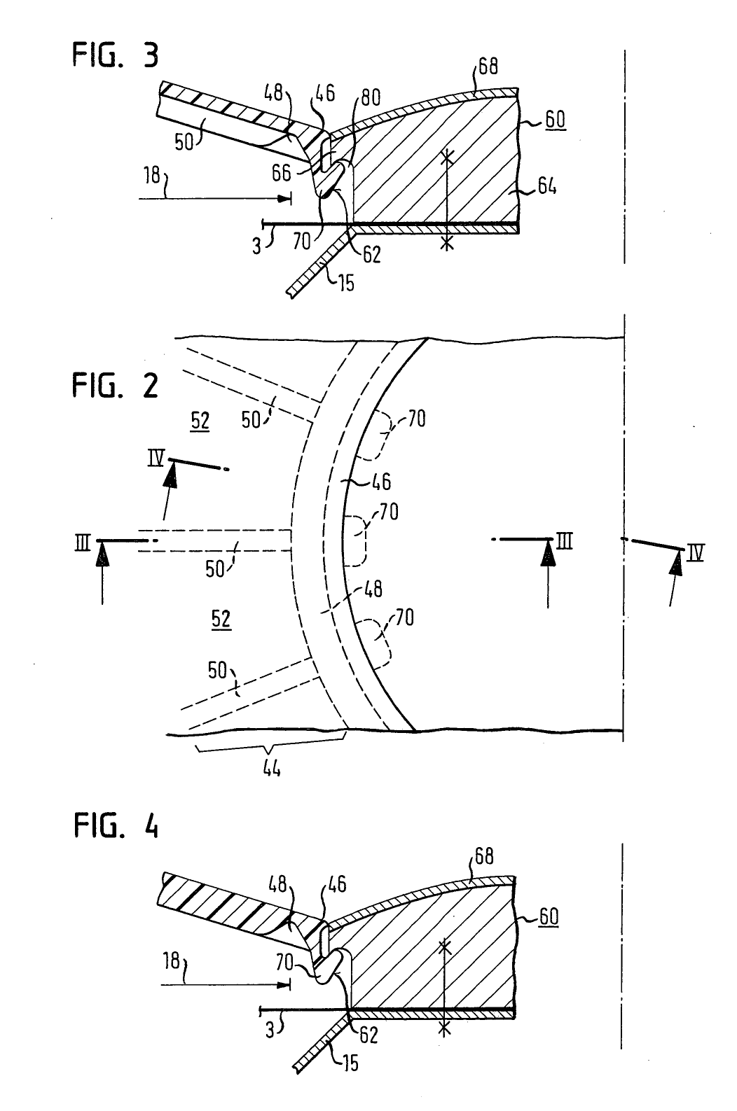

In FIG. 1 a gas bag restraint device is shown with a gas bag module which has a gas bag 3, a gas generator 5 and a cup-shaped module housing 7 closed by a covering cap 9. The gas bag has a wall with several sections, namely with a front wall 11 which faces the occupant who is to be restrained and onto which he can strike in the case of restraint, and also with a rear wall 12. In the region of the front wall 11, a deep indentation 27 is provided in the inflated state, which arises in that a center section 16 of the front wall 11 is permanently fastened to the module, more precisely to a diffusor cage 15 surrounding the gas generator 5, and thereby is prevented from a movement on inflation of the gas bag 3 out from the module. Through the indentation 27, the gas bag is given a ring-shaped chamber 27 which is to be filled with gas. In FIG. 1, the ring-shaped outlet opening 18 is also illustrated, via which the gas bag 3 emerges from the gas bag module. The indentation 27 can also be closed upwardly, e.g. by a suitable cut of the gas bag, with the fully inflated gas bag.

The covering cap 9 consists of several sections, namely a peripheral wall 40 which is fastened to the module housing 7, and a front wall 42. The front wall 42 has several sections, inter alia a section 44 which on opening swings outwards and closes or frees the outlet opening 18. Radially inwards of the section 44, a central section 46 adjoins thereto in one piece, which is delimited from the section 44 by a ring-shaped, closed encircling tear line 48. The tear line 48 is defined by a rear groove. Radial tear lines 50 in a star shape extend outwards over the section 44 from the tear line 48, so that between these tear lines 50 segment-like intermediate sections 52 are formed, which together define the section 44. On tearing, segment-like flaps are produced which, as shown in FIG. 1, swing outwards.

The central section 46 is permanently fastened to the remainder of the module and does not swing outwards. The fastening of the central section 46 takes place through a central plaque piece 60, which projects through a mounting opening 62 in the central section 46 and is fastened to the diffusor cage 15, e.g. by a screw connection.

The plaque piece consists of several sections, namely of a carrier section 64, which has a mushroom shape and at its upper end has a laterally projecting edge 66, and a plaque section 68 applied from the exterior and having a high-quality exterior, preferably with applications of chrome.

The central section 46 has a hook-shaped bead 70 defining the mounting opening 62, which bead 70, as can be seen in comparison with FIGS. 3 and 4, has the hook-shaped end in certain sections only. Under the laterally projecting edge 66, the plaque piece 60 has a groove-like depression 80, in which the bead 70 projects, in order to be additionally held laterally.

The central section extends upwards from the bead 70, to finally terminate flush with the outer side of the plaque section 68. The sides of the carrier section 46 therefore do not have to be lacquered or matched in another way to the high-quality impression of the plaque section 68.

For fastening, the covering cap 9 is simply pushed from above onto the remaining gas bag module, the central section 46 being forced outwards until the inner edge of the central section 46, which is partially formed by the segment-like bead 70, engages behind the laterally projecting edge 66 of the plaque piece 60, i.e. snaps radially inwards, so that a type of detent connection is produced.

This form-fitting detent connection prevents the central section 46 from a free movement on tearing of the covering cap 9. The tear line 48 defines the outer edge of the central section 46 from which, with the covering cap 9 opened, no more segments project radially outwards. An outer edge of the central section 46, closed in a ring shape, is produced. With the covering cap 9 being not open, the tear line 48 immediately adjoins the outlet opening 18, more precisely its inner edge. In the embodiment shown, the inner edge of the outlet opening is even formed by the tear line 48 which defines the smallest internal diameter of the outlet opening 18. As can be seen in FIGS. 3 and 4, the tear line 48, however, also immediately adjoins the outer edge 66 of the plaque piece 60, so that the stability of the central section 46 is very high through the plaque piece 60. By the central section 46 remaining very stable owing to its small dimensions and the fastening on the plaque piece 60, when the covering cap 9 tears open, the tearing force which is required for destroying the covering cap along the tear line 48, is reduced compared with a tear line which lies in an elastically highly deformable region such as for example in the center of the outlet opening 18 or on the outer edge of the outlet opening 18.

1. A gas bag restraint device, comprising
a gas bag module which has a gas bag (3) and a covering cap (9) tearing open on inflation of said gas bag (3),
said covering cap (9) covering a ring-shaped outlet opening (18) for said gas bag (3) and having a central section (46), which in an opened state of said gas bag module is surrounded by said outlet opening (18),
characterized in that said central section (46) is delimited by a ring-shaped, peripherally closed tear line (48) of radially outwardly adjoining sections (44) of said covering cap (9), said tear line adjoining an inner edge of said outlet opening (18).

2. The gas bag restraint device according to claim 1, characterized in that said tear line (48) defines said inner edge of said outlet opening (18).

3. The gas bag restraint device according to claim 1, characterized in that said central section (46) is constructed so as to be rigid.

4. The gas bag restraint device according to claim 1, characterized in that said central section (46) is at least partially covered externally by a separate plaque piece (60).

5. The gas bag restraint device according to claim 4, characterized in that said tear line (48) immediately adjoins an outer edge (66) of said plaque piece (60).

6. The gas bag restraint device according to claim 4, characterized in that said plaque piece (60) fastens said central section (46) and prevents it from a free movement as said covering cap (9) is opening.

7. The gas bag restraint device according to claim 6, characterized in that said plaque piece (60) has a depression (80) at its rear side, into which a bead-like extension (70) of said central section (46) projects.

8. The gas bag restraint device according to claim 6, characterized in that said central section (46) has a mounting opening (62) for said plaque piece (60) and can be placed from above onto said plaque piece (60) such that an inner edge of said central section (46) snaps in place underneath a laterally projecting edge (66) of said plaque piece (60).

9. The gas bag restraint device according to claim 4, characterized in that said covering cap (9) adjoins said plaque piece (60) externally in a substantially flush manner.
